(19) United States
(12) Patent Application Publication
(10) Pub. No.: US 2022/0141091 A1
(43) Pub. Date: May 5, 2022

(54) DIGITAL OWNERSHIP ESCROW FOR NETWORK-CONFIGURABLE DEVICES

(71) Applicant: Microsoft Technology Licensing, LLC, Redmond, WA (US)

(72) Inventors: Hanumantha Rao KOMMALAPATI, Kirkland, WA (US); Nicole Elaine BERDY, Redmond, WA (US); Samuel John GEORGE, Bainbridge Island, WA (US); Cameron William SKINNER, Woodinville, WA (US)

(73) Assignee: Microsoft Technology Licensing, LLC, Redmond, WA (US)

(21) Appl. No.: 17/085,279

(22) Filed: Oct. 30, 2020

(51) Int. Cl. H04L 12/24; H04L 29/06

(52) U.S. Cl. CPC H04L 41/0893; H04L 63/102; H04L 63/0876; H04L 41/0803

(57) ABSTRACT

A method for an escrow computing service comprises maintaining ownership information for a network-configurable device having a unique digital device identifier, the ownership information indicating ownership of the device by a first online identity of a first owner, the ownership information granting access permission for the network-configurable device. The escrow computing service receives a request to transfer ownership of the network-configurable device to a second online identity of a second owner. The ownership information is updated to indicate ownership of the network-configurable device by the second online identity of the second owner. The escrow computing service receives an indication of a network-accessible device management platform to be used to manage the network-configurable device. Upon activation of the network-configurable device, the escrow computing service receives a configuration request from the network-configurable device, and provides the network-configurable device with access information relating to the network-accessible device management platform.

### BACKGROUND

Many modern electronic devices include network interfaces that enable communication with other devices over computer networks, such as the Internet. In this manner, the devices may be accessed, configured, and/or otherwise managed remotely. Some types of such network-configurable devices are sometimes referred to as “Internet of things” (IoT) devices.

### BRIEF DESCRIPTION OF THE DRAWINGS

FIG. 1 schematically shows an example environment including a plurality of network-configurable devices managed by a device management platform.

FIG. 2 illustrates an example method for an escrow computing service.

FIG. 3 schematically illustrates an escrow computing service maintaining ownership information for a network-configurable device.

FIG. 4 schematically illustrates a device manufacturer providing a unique digital device identifier for a network-configurable device.

FIG. 5 schematically illustrates transfer of ownership of a network-configurable device from a first owner to a second owner.

FIG. 6 schematically illustrates configuration of a network-configurable device with a device management platform.

FIG. 7 schematically shows an example computing system.

### DETAILED DESCRIPTION

In many cases, owners and operators of network-configurable devices make use of a suitable network-accessible device management platform to manage and control their devices remotely. Such a platform may, for example, take the form of a cloud IoT management hub, a “platform-as-a-service” (PaaS) solution, an on-premises management platform, and/or other network-accessible service(s) useable to manage and configure a plurality of individual network-configurable devices. Such services will typically be provided by one or more server computers, or other suitable computing devices, working independently or cooperatively. In this manner, device owners and operators may deploy an arbitrarily large number of network-configurable devices (e.g., hundreds, thousands, or more) and remotely manage such devices over a network, rather than spending significant time directly interacting with each individual device's physical hardware.

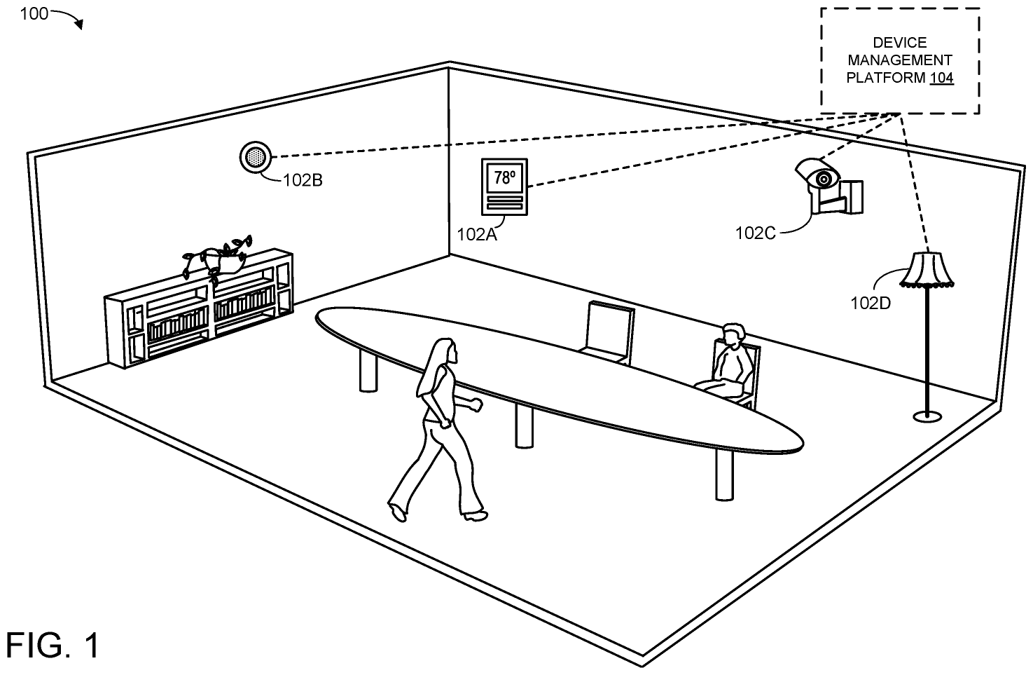

This is schematically illustrated in FIG. 1, which depicts an example real-world environment 100. Environment 100 includes several network-configurable devices 102A (a smart thermostat), 102B (a speaker), 102C (a camera), and 102D (a light source). Each of these devices may include network interface hardware enabling communication with a device management platform 104 over a computer network, such as a local network or the Internet. Such communication may occur over any suitable wired or wireless communication protocol such as, for example, Wi-Fi.

Each of the network-configurable devices may provide functions that are accessible to, or modifiable by, one or more owners or operators of the network-configurable devices via the device management platform. For example, the device management platform may provide a front-end interface (e.g., as a web portal or software application) useable to monitor, configure, and/or control various network-configurable devices. As an example, device 102A may be remotely monitored to determine the current environmental conditions (e.g., temperature) in real-world environment 100, and/or remotely controlled to change behavior of a heating, venting, and air conditioning (HVAC) system communicatively coupled with the thermostat. Similarly, device 102B may be remotely controllable to emit sounds (e.g., music or announcements) in environment 100; device 102C may be accessed to remotely review a feed captured by the camera, and/or change a pan/tilt/zoom of the camera; and device 102D may be accessed to determine and/or change a current level of illumination provided by the light source.

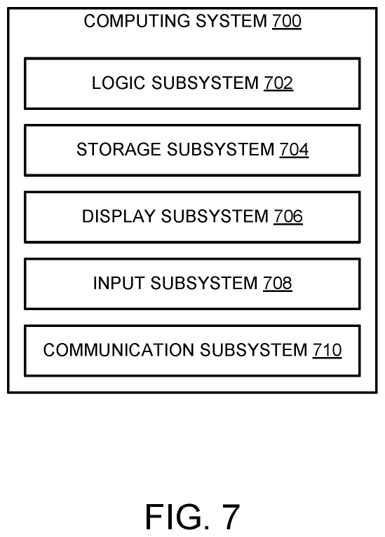

It will be understood that network-configurable devices 102A-102D are non-limiting examples. As used herein, a “network-configurable device” may take the form of any electronic device including one or more hardware components that enable remote access, management, or control of the device over a computer network. As additional non-limiting examples, network-configurable devices may take the form of smart appliances (e.g., refrigerators, dishwashers, laundry machines), building infrastructure (e.g., HVAC systems, elevators), toys, wearable devices (e.g., smart watches), medical devices, environmental monitors (e.g., thermometers, humidity monitors, pH meters), and security devices (e.g., cameras, motion sensors). It will be understood that “configuration” of a network-configurable device need not include modification of the device's behavior, but rather can simply include accessing or reviewing data collected by the device, or the device's current operating state. A “network-configurable device” may in some cases be implemented as computing system 700 described below with respect to FIG. 7.

It is generally desirable that only the device owner(s) and/or one or more explicitly approved operators are able to access, modify, or otherwise manage the network-configurable devices. This may prevent unauthorized parties from retrieving potentially sensitive data associated with the network-configurable devices, or controlling the network-configurable devices in undesirable ways. However, it can be challenging to track and enforce which parties are able to access and control any given network-configurable device, particularly when such devices change hands multiple times before coming into a current owner's possession.

For example, it can be difficult for the current owner of a particular device to trust that no prior owners, or other unauthorized parties, retain any ability to access or control their device—e.g., because such other parties retain access credentials to the device or have previously installed software “backdoors” on the device. While such concerns can be mitigated by manually securing each network-configurable device—e.g., by re-flashing the device or carefully monitoring network traffic received by the device—this can require a significant amount of manual effort for each device, quickly becoming prohibitive when large numbers of devices are involved.

Accordingly, the present disclosure is directed to techniques for securely transferring ownership of a network-configurable device from one owner to another. Specifically, for a particular network-configurable device, an escrow computing service may maintain a unique digital device identifier corresponding to the network-configurable device, and ownership information indicating ownership of the network-configurable device by a current owner. As used herein, the term “escrow” refers to the fact that the digital ownership rights to a network-configurable device may be held by a cloud service that is separate from the parties involved in a transfer of device ownership. Upon transfer of the physical device hardware from one owner to another (e.g., as part of a sales transaction), the ownership information maintained at the escrow computing service may be updated with details corresponding to the new device owner. Furthermore, either of the previous owner or new owner may provide the escrow computing service with information indicating a network-accessible device management platform to be used by the new owner to manage the network-accessible device. Thus, upon activation, the network-configurable device may automatically retrieve information from the escrow computing service relating to the new owner's network-accessible device management platform, and then contact the management platform for further configuration.

Such techniques can simplify the process of securely and easily transferring ownership of a network-configurable device from one party to another. This enables the new device owner to trust that they have control over which parties have permission to access or modify their device, without requiring the new owner to expend significant time and effort securing each new device they purchase. Furthermore, it does not require device manufacturers, sellers, or resellers to maintain detailed local ownership records for the devices they produce or sell, nor does it require manufacturers to produce devices that are specific to particular device management platforms. Instead, tracking of device ownership transactions is performed by a trusted 3^{rd} party escrow service. It also simplifies the initial setup process for new device owners, because the network-configurable device automatically retrieves information regarding the new owner's desired device management platform from the escrow computing service upon activation. Thus, in an example scenario, a new owner may be able to configure their new device on their chosen device management platform shortly after powering the device on for the first time, and without requiring significant interaction with the device's physical hardware

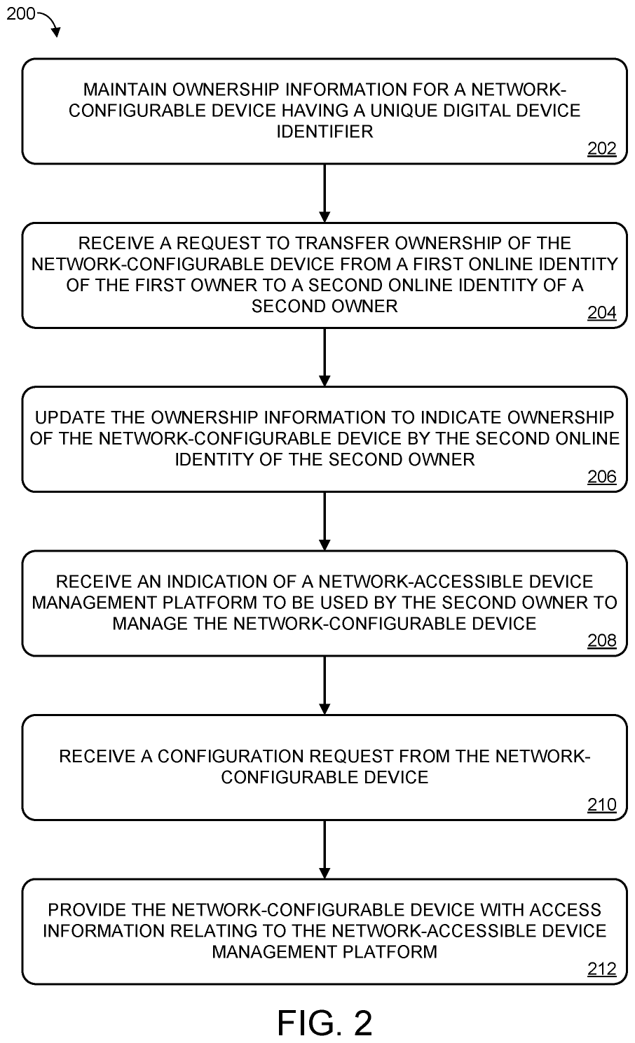

FIG. 2 illustrates an example method 200 for an escrow computing service. Notably, an “escrow computing service” may be provided by one or more separate escrow computing devices working independently or collaboratively. Escrow computing devices may have any suitable hardware configuration and form factor—e.g., an escrow computing device may take the form of a server computer, or other suitable computing device. In some examples, steps of method 200 may be performed by computing system 700 described below with respect to FIG. 7.

At 202, method 200 includes maintaining ownership information for a network-configurable device having a unique digital device identifier. As will be described in more detail below, the ownership information indicates ownership of the network-configurable device by a first online identity of a first owner, and also grants access permission for the network-configurable device. Notably, as used herein, the term “first owner” need not refer to the manufacturer or “original” owner of the device. Rather, the term “first owner” is used to refer to any individual or party who owns a network-configurable device, even if one or more other parties owned the device prior to the first owner, before such ownership is transferred to a “second owner” as will be discussed in more detail below.

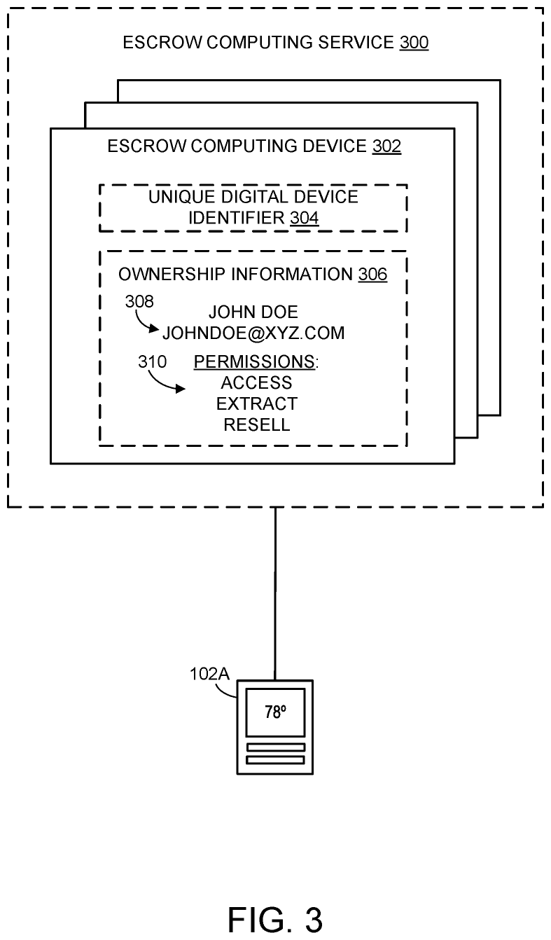

This is schematically illustrated with respect to FIG. 3, which depicts an escrow computing service maintaining ownership information for a network-configurable device. Specifically, FIG. 3 again shows network-configurable device 102A of FIG. 1, in communication with an escrow computing service 300. As indicated above, such communication may be conducted using any suitable wired or wireless communication protocol, and may include exchange of data over the Internet. Furthermore, in FIG. 3, the escrow computing service is provided by a plurality of individual escrow computing devices, including an escrow computing device 302. For the purposes of this disclosure, functions of the escrow computing service are generally described as being performed by escrow computing device 302. It will be understood, however, that such functions may be divided between any number of different devices. Such devices need not each have the same hardware configuration or form factor. Furthermore, such devices (including escrow computing device 302) may be implemented as computing system 700 described below with respect to FIG. 7.

Escrow computing device 302 stores a unique digital device identifier 304 corresponding to network-configurable device 102A. The unique digital device identifier can be viewed as a digital “identity” or “deed” that uniquely corresponds to one particular network-configurable device—in this case, device 102A. It will be understood that other network-configurable devices will have other unique digital device identifiers that may be stored by an escrow computing device. Each unique digital device identifier may take any suitable form. At minimum, the unique digital device identifier will typically include a unique number, such as a universally unique identifier (UUID) or a globally unique identifier (GUID). Such a unique number may have any suitable length—e.g., 128-bits. The unique digital device identifier may additionally include other information pertaining to the network-configurable device, such as the device's make, model, capabilities, software version, etc.

In some cases, the unique digital device identifier may be the same as, or related to, a unique physical hardware identifier that is hardcoded into the network-configurable device. For example, during manufacturing of the network-configurable device, the manufacturer may generate a unique physical hardware identifier that is encoded into one or more hardware components of the device. This may include a main memory of the device, a device processor, or a secure coprocessor that is isolated from a user-configurable software environment of the device.

Such a unique physical hardware identifier may be used as a method of authentication for communication between the network-configurable device and the escrow computing service. For example, in cases where the unique digital device identifier is the same as the unique physical hardware identifier, or a transformed version (e.g., one identifier may be a hashed or encrypted version of the other), then the network-configurable device may confirm the validity of the escrow computing service by comparing its hardware identifier to the unique digital device identifier stored by the escrow computing service. In one approach, the escrow computing service may transmit the unique digital device identifier (or an encrypted version of the device identifier) to the network-configurable device over a mutually authenticated encrypted channel, which may confirm that the received unique digital device identifier is consistent with its own hardware identifier. This may demonstrate that the escrow computing service is authentic and is not, for example, a malicious party masquerading as the escrow computing service. Additionally, or alternatively, the escrow computing service may receive the hardware identifier (or an encrypted version of the hardware identifier) from the network-configurable device and compare it to the stored unique digital device identifier. This may demonstrate that the network-configurable device is authentic and is not, for example, malicious or counterfeit.

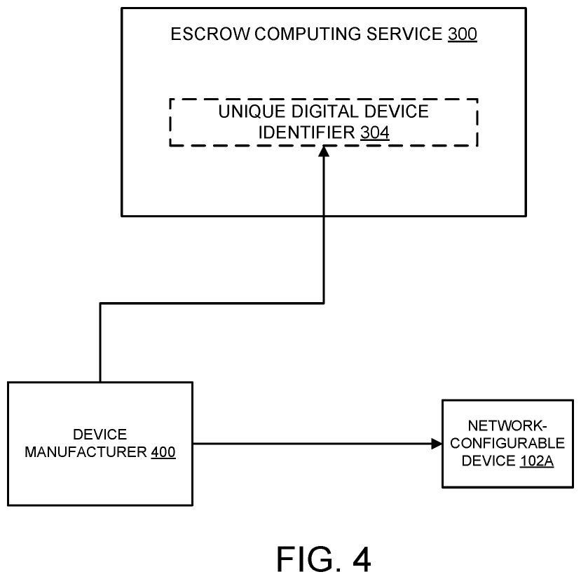

In any case, the escrow computing service stores the unique digital device identifier, which may be received from the original device manufacturer, or another suitable trusted party (e.g., a different escrow service). This is schematically illustrated with respect to FIG. 4, depicting a device manufacturer 400 that produced network-configurable device 102A. As shown, device manufacturer 400 provides the unique digital device identifier 304 to escrow computing service 300. Notably, the unique digital device identifier may be received by any device that contributes to implementing the escrow computing service. In other words, the unique digital device identifier need not be received by the same escrow computing device(s) that perform steps of method 200.

The device manufacturer may transmit the unique digital device identifier to the escrow computing service in any suitable way. In one example, the escrow computing service may maintain one or more application programming interfaces (APIs) useable by various parties (e.g., device manufacturers, owners, sellers, resellers) to send data to, or receive data from, the escrow computing service in a standardized manner. Thus, via a standard API provided by the escrow computing service, any supported device manufacturer may provide unique digital device identifiers to the escrow computing service for any supported network-configurable devices.

Returning to FIG. 3, escrow computing device 302 also maintains ownership information 306, indicating ownership of the network-configurable device by a first online identity 308 of a first owner of the device. An “owner” of a network-configurable device may include an individual user, or the owner may be a collective (e.g., such as a company or organization). In one example, the manufacturer of the network-configurable device may be the first owner, or the first owner may be an individual, organization, or seller (e.g., online marketplace) that has previously purchased the network-configurable device from the manufacturer, or an intermediary seller (e.g., a business-to-business (B2B) reseller). In this example, the escrow computing device stores both a real name of the first owner (i.e., John Doe), as well as an online identity of the first owner (i.e., JohnDoe@xyz.com). It will be understood, however, that this is done for illustration purposes only. In practical scenarios, the ownership information need not include the owner's real name, only an online identity of the owner.

As used herein, an “online identity” refers to an online account or credential that can be used to authenticate the identity of a device owner online. In other words, an online identity of a device owner may refer to an online account accessible by the owner after authentication via a suitable authentication method. Examples of suitable authentication methods may include providing a password corresponding to a username of the owner, selecting a link or providing a code transmitted to the owner via a suitable communication method (e.g., email, text message, instant message), providing a biometric identifier (e.g., fingerprint scan, facial recognition, iris scan, voiceprint analysis), or and/or verifying a physical hardware key kept by the owner. Verification of online identities may be outsourced to trusted 3^{rd} party identity providers—e.g., services that create and manage identity information to provide user authentication as a service. Examples of an online identity may include social identities—e.g., a social media account for an online social media service, an email account, an online account for an online marketplace—and/or enterprise identities—e.g., corresponding to an online account for a network-accessible device management platform.

Storing the online identity for the device owner may enable the escrow computing service to authenticate the owner any time they attempt to access the escrow service and/or claim or configure a network-configurable device. For example, upon attempting to access the escrow computing service, the owner may be required to provide credentials validating that they control the online identity stored by the escrow computing service. The owner's credentials may be evaluated by the escrow computing service itself (e.g., compared to a known password stored by the escrow service), and/or the owner's credentials may be passed along to a 3^{rd} party identity provider as discussed above.

Use of an online identity as described herein may simplify the process of claiming ownership of a network-configurable device. An alternate approach may include, for example, requiring owners to maintain cryptographic public/private keypairs, and digitally signing a digital ownership chain using their public key. This can be cumbersome in practice, especially for users that are not technically inclined. Furthermore, as will be discussed in more detail below, use of online identities may simplify the process of transferring ownership from one party to another. For example, in a common scenario in which a new owner purchases a network-configurable device from an online marketplace, the new owner's identity has likely already been securely authenticated by the online marketplace. Thus, the owner's online marketplace account can be used as the owner's online identity, for the purposes of verifying their ownership of the network-configurable device.

Continuing with FIG. 3, the ownership information also includes permissions 310 indicating various permissions held by the first owner with respect to the network-configurable device. Typically, the ownership information will at least grant access permission for the owner to access information regarding the network-configurable device from the escrow computing service. As non-limiting examples, the permissions may include a READ_DEVICE_IDENTITY permission allowing the first owner to access the escrow service and review the unique digital device identifier of the network-configurable device. An EXTRACT_DEVICE_IDENTITY permission may enable the owner to extract the unique digital device identifier from the escrow computing service—e.g., for archiving or transfer to a different escrow service. Similarly, an ENROLL_DEVICE_IDENTITY permission may enable the owner (or other authorized user) to deploy the device for use with a network-accessible device management platform.

As another example, the ownership information may grant a DELEGATE_OWNERSHIP permission to transfer ownership of the network-configurable device to a subsequent owner. For example, this may be done during sale of the network-configurable device, or to grant permissions to a contractor for service delivery. This is the case in the example of FIG. 3, in which the online identity of the first owner has permissions to access, extract, and resell the network-configurable device. Notably, however, device owners may have any suitable combinations of privileges. For example, one owner may delegate device ownership to a second owner without providing the second owner with “resell” privileges, which may be applicable in a scenario in which the second owner is a contractor that will provide subsequent device commissioning and operational support.

In some cases, the ownership information may maintain permissions for one or more individuals or parties other than the current owner of the network-configurable device. For example, the first owner may list the network-configurable device for sale on an online marketplace, while retaining their status as the owner of the device. Nonetheless, the ownership information may grant permission to the online marketplace to sell the network-configurable device on behalf of the first owner. In another example, the first owner may authorize another party (e.g., a contractor) to access and modify the network-configurable device on the first owner's behalf, while retaining exclusive permission to transfer ownership of the device to a different party. In general, the ownership information may maintain any number of different permissions for different parties, including parties other than the current device owner.

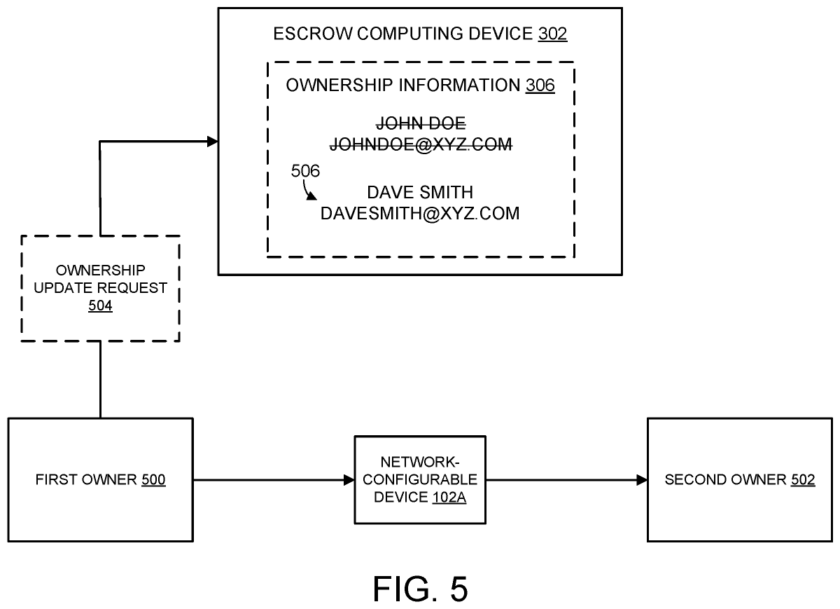

Returning briefly to FIG. 2, at 204, method 200 includes receiving a request to transfer ownership of the network-configurable device from the online identity of the first owner to an online identity of a second owner. This is schematically illustrated with respect to FIG. 5, in which ownership of network-configurable device 102A is transferred from a first owner 500 to a second owner 502. Correspondingly, escrow computing device 302 receives an ownership update request 504 from the first owner.

The ownership update request may be received in any suitable way. Typically, the escrow computing device will receive the ownership update request from the current owner of the network-configurable device, or an entity granted permissions by the owner to transfer ownership of the network-configurable device on the owner's behalf. As discussed above, the escrow computing service may maintain one or more APIs through which various parties (e.g., manufacturers, owners, sellers) may exchange data with the escrow service in a standardized form. Thus, the first owner may transmit the ownership update request via a suitable API of the escrow computing service.

In some cases, such an API may be supported by an online marketplace used to sell the network-configurable device. For example, the first owner may be an online marketplace (or the first owner may authorize an online marketplace to the sell the device on their behalf), and the second owner may be a customer of the online marketplace. As part of a sales transaction in which the second owner purchases the network-configurable device, the online marketplace may automatically send the ownership update request to the escrow computing service via a suitable API—e.g., after completion of an online “checkout” process.

Furthermore, the ownership update request may include any suitable contents. Typically, the ownership update request will specify the identity of the network-configurable device in question—e.g., by referencing the unique digital device identifier. The ownership update request will also specify how the ownership of the network-configurable device is to be changed—e.g., by revoking the first owner's permissions and granting new permissions to the online identity of the second owner. In some cases, the escrow computing service may authenticate the first owner's identity before applying the change in ownership. For example, the first owner may only be allowed to submit an ownership update request after previously validating their control over the first online identity through a suitable authentication procedure, as discussed above.

Returning briefly to FIG. 2, at 206, method 200 includes updating the ownership information to indicate ownership of the network-configurable device by the second online identity of the second owner. This is also schematically illustrated with respect to FIG. 5. As shown, ownership information 306 is updated to replace the first online identity of the first owner with a second online identity 506 of a second owner. Notably, the escrow computing service may in some cases retain information regarding the first owner's prior ownership of the device, and/or any other prior ownership information for other prior owners. For example, the escrow computing service may retain the first online identity, the length of time that the device was owned by the first owner, and what permissions were held by the first owner. Such information, however, may or may not be available to current device owners and/or other parties.

In many cases, transfer of ownership of a network-configurable device from one owner to another will revoke any and all permissions held by the first owner with respect to the device. In other words, the ownership information, after being updated to indicate ownership of the network-configurable device by the second online identity of the second owner, revokes access permission for the network-configurable device from the first owner. In other examples, however, the first owner may retain some permissions after the ownership transfer, on either a short-term or long-term basis. For instance, the first owner may retain some ability to access or monitor the network-configurable device, even as the second owner holds exclusive permissions to modify or resell the network-configurable device.

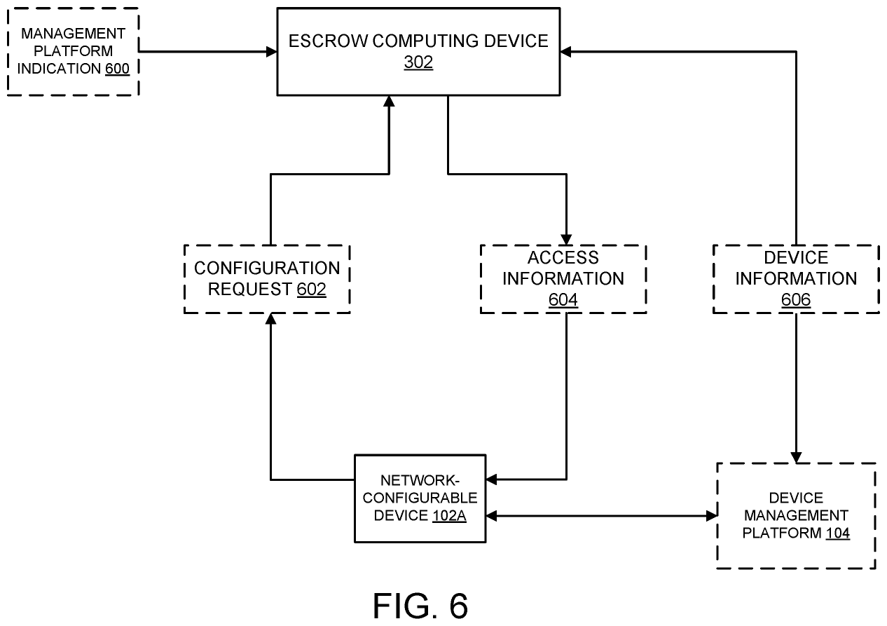

Returning briefly to FIG. 2, at 208, method 200 includes receiving an indication of a network-accessible device management platform to be used by the second owner to manage the network-configurable device. This is schematically illustrated in FIG. 6, in which escrow computing device 302 receives a management platform indication 602.

As discussed above, owners and operators of network-configurable devices often make use of suitable network-accessible device management platforms to manage and control their devices remotely. Such a platform may, for example, take the form of a cloud IoT management hub, a “platform-as-a-service” (PaaS) solution, an on-premises management platform, and/or other network-accessible service(s) useable to manage and configure a plurality of individual network-configurable devices. Owners and operators of network-configurable devices often access such services through front-end interfaces provided by the service—e.g., via a webpage or software application—through which they are able to review, monitor, and/or reconfigure any or all of their network-configurable devices that are supported by the management platform.

It can be tedious and time-consuming for end users to configure their network-configurable devices for use with their desired network-accessible device management platform. This leads to a scenario in which some device manufacturers sell platform-specific versions of their devices, leading to added complexity and potential confusion. By contrast, according to the techniques described herein, network-configurable devices may be used with any device management platform specified by the device owner and supported by the escrow computing service. During ownership transfer of a network-configurable device from a first owner to a second owner, either owner may provide an indication (e.g., indication 600) of which network-accessible device management platform the second owner would like to use the network-configurable device with. Such information may be stored by the escrow computing service for later use, as will be described in more detail below.

The management platform indication may be received at the escrow computing device from either the first owner or the second owner. In some examples, the second owner may be asked to specify their desired management platform during the process of purchasing the network-configurable device from the first owner. For example, in a case where the second owner purchases the network-configurable device from an online marketplace, the second owner may be prompted during the transaction (e.g., during or after a “checkout” phase) to specify their desired management platform, if any. After receiving such information from the second owner, the first owner or online marketplace (in cases where the first owner and online marketplace are different) may provide the management platform indication to the escrow computing device. In other words, the indication of the network-accessible device management platform may be received by the escrow computing service from the online marketplace and specified by the second owner during purchase of the network-configurable device.

Alternatively, the management platform indication may be received by the escrow computing service directly from the second owner who may, for example, manually log into the escrow computing service and provide such information after acquiring the network-configurable device. In other words, the indication of the network-accessible device management platform may be received by the escrow computing service from the second owner after purchase of the network-configurable device.

In any case, the desired network-accessible device management platform may be specified in any suitable way. In some cases, the management platform indication may refer to the desired management platform according to a human-readable service name—e.g., the Microsoft Device Provisioning Service, which in turn provisions devices into the Azure® IoT Hub. The escrow computing service may then resolve the human-readable service name to a specific network address (e.g., IP address) according to a local index maintained by the escrow computing service or a 3^{rd} party index. Alternatively, the management platform indication may directly specify the network address, such as an IP address, for the desired management platform. Once received, the escrow computing service may store such information in any suitable —e.g., as part of the ownership information for the network-accessible device.

Returning briefly to FIG. 2, at 210, method 200 includes receiving a configuration request from the network-configurable device. At 212, method 200 includes providing the network-configurable device with access information relating to the network-accessible device management platform. This is also schematically illustrated in FIG. 6. As shown, the escrow computing device receives a configuration request 602 from network-configurable device 102A, and the network-configurable device is provided with access information 604 by the escrow computing service. Based on the access information, network-configurable device 102A contacts and exchanges data with device management platform 104. Notably, “providing” the network-configurable device with the access information may include either or both of the escrow computing device actively transmitting the access information to the network-configurable device, and the network-configurable device actively reading the access information from the escrow computing device.

After receiving the indication of the network-accessible device management platform to be used by the second owner to manage the network-configurable device, the escrow computing device sends device identity information 606 for the network-configurable device to the network-accessible device management platform. Such device identity information may be useable by the device management platform to authenticate the network-configurable device, once the network-configurable device contacts the device management platform after receiving the access information from the escrow service. The specific contents of the device identity information will vary from implementation to implementation. Typically, it will include some indication of the device's identity—e.g., some representation of the unique digital device identifier or physical device identifier—that the device itself can confirm upon contacting the device management platform. In one example, the escrow service may provide each of the network-configurable device and device management platform with matching or complementary credentials, allowing both the device and management platform to verify that they have both been trusted by the escrow service. In some implementations, the device identity information may include information regarding the device's configuration or capabilities—e.g., the device's make, model, hardware configuration, or software configuration.

This will typically occur after successful transfer of ownership of the network-configurable device from the first owner to the second owner, and installation/activation of the network-configurable device. For example, in some cases, each network-configurable device supported by the escrow computing service may be configured to, upon initial activation, contact the escrow computing service—e.g., at a hardcoded “phone home” address. At this time, the network-configurable device may be provided with ownership information regarding the device's new owner, and/or the access information useable by the network-configurable device to contact the specified device management platform. For example, the access information may include a network address (e.g., IP address) at which the network-configurable device may contact a web server (or other suitable computing device) associated with the device management platform, and/or the network-configurable device may be provided with other suitable information useable to contact the specified device management platform.

The network-configurable device may exchange any suitable information with the device management platform. In many cases, the network-configurable device may provide the device management platform with some information regarding the device's specifications—e.g., the device manufacturer, model, hardware configuration, or capabilities. Additionally, or alternatively, the network-configurable device may provide the device management platform with some indication of the device's current owner. For instance, the network-configurable device may communicate the online identity of the device's current owner, provided by the escrow computing service, to the device management platform. The online identity may be the same as, or otherwise correspond to, an existing account held by the device owner on the device management platform. Thus, in one example scenario, the network-configurable device may be provisioned for use on the network-accessible device management platform substantially “behind-the-scenes,” with little to no manual effort required from the device owner. Rather, after purchasing and installing the network-configurable device, the device owner may discover that the device has automatically been added to their management platform account a short time later, from which the device owner is able to monitor and/or modify the device's behavior. This has the effect of greatly reducing the time and effort required from the device owner to enroll and use new devices with their preferred device management platform, particularly when the device owner purchases and installs large numbers (e.g., dozens, hundreds, thousands, or more) network configurable devices in bulk.

The methods and processes described herein may be tied to a computing system of one or more computing devices. For example, the methods and processes described herein may be performed by one or more escrow computing devices of an escrow computing service. In particular, such methods and processes may be implemented as an executable computer-application program, a network-accessible computing service, an application-programming interface (API), a library, or a combination of the above and/or other compute resources.

FIG. 7 schematically shows a simplified representation of a computing system 700 configured to provide any to all of the compute functionality described herein. Computing system 700 may take the form of one or more personal computers, network-accessible server computers, tablet computers, home-entertainment computers, gaming devices, mobile computing devices, mobile communication devices (e.g., smart phone), virtual/augmented/mixed reality computing devices, wearable computing devices, Internet of Things (IoT) devices, embedded computing devices, and/or other computing devices.

Computing system 700 includes a logic subsystem 702 and a storage subsystem 704. Computing system 700 may optionally include a display subsystem 706, input subsystem 708, communication subsystem 710, and/or other subsystems not shown in FIG. 7.

Logic subsystem 702 includes one or more physical devices configured to execute instructions. For example, the logic subsystem may be configured to execute instructions that are part of one or more applications, services, or other logical constructs. The logic subsystem may include one or more hardware processors configured to execute software instructions. Additionally, or alternatively, the logic subsystem may include one or more hardware or firmware devices configured to execute hardware or firmware instructions. Processors of the logic subsystem may be single-core or multi-core, and the instructions executed thereon may be configured for sequential, parallel, and/or distributed processing. Individual components of the logic subsystem optionally may be distributed among two or more separate devices, which may be remotely located and/or configured for coordinated processing. Aspects of the logic subsystem may be virtualized and executed by remotely-accessible, networked computing devices configured in a cloud-computing configuration.

Storage subsystem 704 includes one or more physical devices configured to temporarily and/or permanently hold computer information such as data and instructions executable by the logic subsystem. When the storage subsystem includes two or more devices, the devices may be collocated and/or remotely located. Storage subsystem 704 may include volatile, nonvolatile, dynamic, static, read/write, read-only, random-access, sequential-access, location-addressable, file-addressable, and/or content-addressable devices. Storage subsystem 704 may include removable and/or built-in devices. When the logic subsystem executes instructions, the state of storage subsystem 704 may be transformed—e.g., to hold different data.

Aspects of logic subsystem 702 and storage subsystem 704 may be integrated together into one or more hardware-logic components. Such hardware-logic components may include program- and application-specific integrated circuits (PASIC/ASICs), program- and application-specific standard products (PSSP/ASSPs), system-on-a-chip (SOC), and complex programmable logic devices (CPLDs), for example.

The logic subsystem and the storage subsystem may cooperate to instantiate one or more logic machines. As used herein, the term “machine” is used to collectively refer to the combination of hardware, firmware, software, instructions, and/or any other components cooperating to provide computer functionality. In other words, “machines” are never abstract ideas and always have a tangible form. A machine may be instantiated by a single computing device, or a machine may include two or more sub-components instantiated by two or more different computing devices. In some implementations a machine includes a local component (e.g., software application executed by a computer processor) cooperating with a remote component (e.g., cloud computing service provided by a network of server computers). The software and/or other instructions that give a particular machine its functionality may optionally be saved as one or more unexecuted modules on one or more suitable storage devices.

When included, display subsystem 706 may be used to present a visual representation of data held by storage subsystem 704. This visual representation may take the form of a graphical user interface (GUI). Display subsystem 706 may include one or more display devices utilizing virtually any type of technology. In some implementations, display subsystem may include one or more virtual-, augmented-, or mixed reality displays.

When included, input subsystem 708 may comprise or interface with one or more input devices. An input device may include a sensor device or a user input device. Examples of user input devices include a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition.

When included, communication subsystem 710 may be configured to communicatively couple computing system 700 with one or more other computing devices. Communication subsystem 710 may include wired and/or wireless communication devices compatible with one or more different communication protocols. The communication subsystem may be configured for communication via personal-, local- and/or wide-area networks.

The methods and processes disclosed herein may be configured to give users and/or any other humans control over any private and/or potentially sensitive data. Whenever data is stored, accessed, and/or processed, the data may be handled in accordance with privacy and/or security standards. When user data is collected, users or other stakeholders may designate how the data is to be used and/or stored. Whenever user data is collected for any purpose, the user data may only be collected with the utmost respect for user privacy (e.g., user data may be collected only when the user owning the data provides affirmative consent, and/or the user owning the data may be notified whenever the user data is collected). If the data is to be released for access by anyone other than the user or used for any decision-making process, the user's consent may be collected before using and/or releasing the data. Users may opt-in and/or opt-out of data collection at any time. After data has been collected, users may issue a command to delete the data, and/or restrict access to the data. All potentially sensitive data optionally may be encrypted and/or, when feasible, anonymized, to further protect user privacy. Users may designate portions of data, metadata, or statistics/results of processing data for release to other parties, e.g., for further processing. Data that is private and/or confidential may be kept completely private, e.g., only decrypted temporarily for processing, or only decrypted for processing on a user device and otherwise stored in encrypted form. Users may hold and control encryption keys for the encrypted data. Alternately or additionally, users may designate a trusted third party to hold and control encryption keys for the encrypted data, e.g., so as to provide access to the data to the user according to a suitable authentication protocol.

This disclosure is presented by way of example and with reference to the associated drawing figures. Components, process steps, and other elements that may be substantially the same in one or more of the figures are identified coordinately and are described with minimal repetition. It will be noted, however, that elements identified coordinately may also differ to some degree. It will be further noted that some figures may be schematic and not drawn to scale. The various drawing scales, aspect ratios, and numbers of components shown in the figures may be purposely distorted to make certain features or relationships easier to see.

In an example, a method for operating an escrow computing service comprises: at the escrow computing service, maintaining ownership information for a network-configurable device having a unique digital device identifier, the ownership information indicating ownership of the network-configurable device by a first online identity of a first owner, the ownership information granting access permission for the network-configurable device; receiving, at the escrow computing service and from the first owner, a request to transfer ownership of the network-configurable device from the first online identity of the first owner to a second online identity of a second owner; updating the ownership information maintained by the escrow computing service to indicate ownership of the network-configurable device by the second online identity of the second owner; receiving, at the escrow computing service, an indication of a network-accessible device management platform to be used by the second owner to manage the network-configurable device; upon activation of the network-configurable device, receiving, at the escrow computing service, a configuration request from the network-configurable device; and providing the network-configurable device with access information relating to the network-accessible device management platform. In this example or any other example, one or both of the first and second online identities is an online account for an online marketplace. In this example or any other example, one or both of the first and second online identities is a social media account for an online social media service. In this example or any other example, one or both of the first and second online identities is an online account for a network-accessible device management platform. In this example or any other example, the network-configurable device is listed for sale on an online marketplace by the first owner, and where the ownership information grants permission to the online marketplace to sell the network-configurable device on behalf of the first owner. In this example or any other example, the indication of the network-accessible device management platform is received by the escrow computing service from the online marketplace, and specified by the second owner during purchase of the network-configurable device. In this example or any other example, the indication of the network-accessible device management platform is received by the escrow computing service from the second owner after purchase of the network-configurable device. In this example or any other example, the first owner is an online marketplace, and the second owner is a customer of the online marketplace. In this example or any other example, the ownership information further grants permission to extract the unique digital device identifier for the network-configurable device from the escrow computing service. In this example or any other example, the ownership information further grants permission to transfer ownership of the network-configurable device to a subsequent owner. In this example or any other example, the method further comprises receiving, at the escrow computing service, the unique digital device identifier for the network-configurable device from a manufacturer of the network-configurable device. In this example or any other example, the manufacturer of the network-configurable device is the first owner. In this example or any other example, the ownership information, after being updated to indicate ownership of the network-configurable device by the second online identity of the second owner, revokes access permission for the network-configurable device from the first owner. In this example or any other example, the method further comprises, after receiving the indication of the network-accessible device management platform to be used by the second owner to manage the network-configurable device, sending device identity information for the network-configurable device to the network-accessible device management platform.

In an example, an escrow computing device comprises: a logic machine; and a storage machine holding instructions executable by the logic machine to: maintain ownership information for a network-configurable device having a unique digital device identifier, the ownership information indicating ownership of the network-configurable device by a first online identity of a first owner, the ownership information granting access permission for the network-configurable device; receive, from the first owner, a request to transfer ownership of the network-configurable device from the first online identity of the first owner to a second online identity of a second owner; update the ownership information to indicate ownership of the network-configurable device by the second online identity of the second owner; receive an indication of a network-accessible device management platform to be used by the second owner to manage the network-configurable device; upon activation of the network-configurable device, receive a configuration request from the network-configurable device; and provide the network-configurable device with access information relating to the network-accessible device management platform. In this example or any other example, the network-configurable device is listed for sale on an online marketplace by the first owner, and the ownership information grants permission to the online marketplace to sell the network-configurable device on behalf of the first owner. In this example or any other example, the indication of the network-accessible device management platform is received by the escrow computing service from the online marketplace, and specified by the second owner during purchase of the network-configurable device. In this example or any other example, the instructions are further executable to receive the unique digital device identifier for the network-configurable device from a manufacturer of the network-configurable device. In this example or any other example, the first online identity of the first owner is an online account accessible by the first owner after authentication, and the second online identity of the second owner is an online account accessible by the second owner after authentication.

In an example, a method for operating an escrow computing service comprises: at the escrow computing service, maintaining ownership information for a network-configurable device having a unique digital device identifier, the ownership information indicating ownership of the network-configurable device by a manufacturer of the network-configurable device, the ownership information granting access permission for the network-configurable device; receiving, at the escrow computing service and from the manufacturer, a request to transfer ownership of the network-configurable device from the manufacturer to a first online identity of a first owner; updating the ownership information maintained by the escrow computing service to indicate ownership of the network-configurable device by the first online identity of the first owner; receiving, at the escrow computing service and from the first owner, a request to transfer ownership of the network-configurable device from the first online identity of the first owner to a second online identity of a second owner based on a purchase of the network-configurable device by the second owner; updating the ownership information maintained by the escrow computing service to indicate ownership of the network-configurable device by the second online identity of the second owner; receiving, at the escrow computing service, an indication of a network-accessible device management platform to be used by the second owner to manage the network-configurable device; upon activation of the network-configurable device, receiving, at the escrow computing service, a configuration request from the network-configurable device; and providing the network-configurable device with access information relating to the network-accessible device management platform.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A method for operating an escrow computing service, the method comprising:
at the escrow computing service, maintaining ownership information for a network-configurable device having a unique digital device identifier, the ownership information indicating ownership of the network-configurable device by a first online identity of a first owner, the ownership information granting access permission for the network-configurable device;
receiving, at the escrow computing service and from the first owner, a request to transfer ownership of the network-configurable device from the first online identity of the first owner to a second online identity of a second owner;
updating the ownership information maintained by the escrow computing service to indicate ownership of the network-configurable device by the second online identity of the second owner;
receiving, at the escrow computing service, an indication of a network-accessible device management platform to be used by the second owner to manage the network-configurable device;
upon activation of the network-configurable device, receiving, at the escrow computing service, a configuration request from the network-configurable device; and
providing the network-configurable device with access information relating to the network-accessible device management platform.

2. The method of claim 1, where one or both of the first and second online identities is an online account for an online marketplace.

3. The method of claim 1, where one or both of the first and second online identities is a social media account for an online social media service.

4. The method of claim 1, where one or both of the first and second online identities is an online account for a network-accessible device management platform.

5. The method of claim 1, where the network-configurable device is listed for sale on an online marketplace by the first owner, and where the ownership information grants permission to the online marketplace to sell the network-configurable device on behalf of the first owner.

6. The method of claim 5, where the indication of the network-accessible device management platform is received by the escrow computing service from the online marketplace, and specified by the second owner during purchase of the network-configurable device.

7. The method of claim 5, where the indication of the network-accessible device management platform is received by the escrow computing service from the second owner after purchase of the network-configurable device.

8. The method of claim 1, where the first owner is an online marketplace, and the second owner is a customer of the online marketplace.

9. The method of claim 1, where the ownership information further grants permission to extract the unique digital device identifier for the network-configurable device from the escrow computing service.

10. The method of claim 1, where the ownership information further grants permission to transfer ownership of the network-configurable device to a subsequent owner.

11. The method of claim 1, further comprising receiving, at the escrow computing service, the unique digital device identifier for the network-configurable device from a manufacturer of the network-configurable device.

12. The method of claim 11, where the manufacturer of the network-configurable device is the first owner.

13. The method of claim 1, where the ownership information, after being updated to indicate ownership of the network-configurable device by the second online identity of the second owner, revokes access permission for the network-configurable device from the first owner.

14. The method of claim 1, further comprising, after receiving the indication of the network-accessible device management platform to be used by the second owner to manage the network-configurable device, sending device identity information for the network-configurable device to the network-accessible device management platform.

15. An escrow computing device, comprising:
a logic machine; and
a storage machine holding instructions executable by the logic machine to:
maintain ownership information for a network-configurable device having a unique digital device identifier, the ownership information indicating ownership of the network-configurable device by a first online identity of a first owner, the ownership information granting access permission for the network-configurable device;
receive, from the first owner, a request to transfer ownership of the network-configurable device from the first online identity of the first owner to a second online identity of a second owner;
update the ownership information to indicate ownership of the network-configurable device by the second online identity of the second owner;
receive an indication of a network-accessible device management platform to be used by the second owner to manage the network-configurable device;
upon activation of the network-configurable device, receive a configuration request from the network-configurable device; and
provide the network-configurable device with access information relating to the network-accessible device management platform.

16. The escrow computing device of claim 15, where the network-configurable device is listed for sale on an online marketplace by the first owner, and where the ownership information grants permission to the online marketplace to sell the network-configurable device on behalf of the first owner.

17. The escrow computing device of claim 16, where the indication of the network-accessible device management platform is received by the escrow computing service from the online marketplace, and specified by the second owner during purchase of the network-configurable device.

18. The escrow computing device of claim 15, where the instructions are further executable to receive the unique digital device identifier for the network-configurable device from a manufacturer of the network-configurable device.

19. The escrow computing device of claim 15, where the first online identity of the first owner is an online account accessible by the first owner after authentication, and where the second online identity of the second owner is an online account accessible by the second owner after authentication.

20. A method for operating an escrow computing service, the method comprising:
at the escrow computing service, maintaining ownership information for a network-configurable device having a unique digital device identifier, the ownership information indicating ownership of the network-configurable device by a manufacturer of the network-configurable device, the ownership information granting access permission for the network-configurable device;
receiving, at the escrow computing service and from the manufacturer, a request to transfer ownership of the network-configurable device from the manufacturer to a first online identity of a first owner;
updating the ownership information maintained by the escrow computing service to indicate ownership of the network-configurable device by the first online identity of the first owner;
receiving, at the escrow computing service and from the first owner, a request to transfer ownership of the network-configurable device from the first online identity of the first owner to a second online identity of a second owner based on a purchase of the network-configurable device by the second owner;
updating the ownership information maintained by the escrow computing service to indicate ownership of the network-configurable device by the second online identity of the second owner;
receiving, at the escrow computing service, an indication of a network-accessible device management platform to be used by the second owner to manage the network-configurable device;
upon activation of the network-configurable device, receiving, at the escrow computing service, a configuration request from the network-configurable device; and
providing the network-configurable device with access information relating to the network-accessible device management platform.
